(19) United States
(12) Patent Application Publication
(10) Pub. No.: US 2022/0064042 A1
(43) Pub. Date: Mar. 3, 2022

(54) MULTISTAGE SEPARATION REACTION TANK AND METHOD FOR TREATING SEWAGE SLUDGE BY USING ALKANE-BASED SOLVENT USING SAME

(71) Applicant: FIVE AND SIX CO., LTD., Seongnam (KR)

(72) Inventors: Jae-kyu JI, Goyang (KR); Dong-cheol SHIN, Ulsan (KR)

(21) Appl. No.: 17/417,978

(22) PCT Filed: Dec. 12, 2019
(86) PCT No.: PCT/KR2019/017551

§ 371 Date: Jun. 24, 2021

(30) Foreign Application Priority Data
Dec. 24, 2018 (KR) 10-2018-0168159

(51) Int. Cl. C02F 11/00; C02F 3/12; C02F 11/14

(52) U.S. Cl. CPC C02F 11/002; C02F 3/1215; C02F 2209/10; C02F 11/14; C02F 3/121

(57) ABSTRACT

The present invention relates to a multistage separation reaction tank for treating sewage sludge by forming a collection layer, a diffusion layer, a primary buffer layer, a secondary buffer layer, and an inorganic precipitate layer when treating an organic material by adding a liquid solvent having a specific gravity less than water to the sewage sludge. In addition, the present invention relates to a method for treating sewage sludge by using an alkane-based solvent, wherein the method significantly lowers the water content of the sewage sludge by using an alkane-based solvent which is in a liquid state and non-polar at atmospheric pressure and room temperature.

### TECHNICAL FIELD

The present invention relates to a multistage separation reaction tank for treating sewage sludge by forming a collection layer, a diffusion layer, a primary buffer layer, a secondary buffer layer, and an inorganic precipitate layer when treating an organic material by adding a liquid solvent having a lower specific gravity than water to the sewage sludge.

In addition, the present invention relates to a method of treating sewage sludge using an alkane-based solvent, which significantly lowers the water content of the sewage sludge using an alkane-based solvent that is in a liquid state and non-polar at atmospheric pressure and room temperature.

### BACKGROUND ART

Recently, as the illegal discharge or dumping of sewage sludge causing environmental pollution is prohibited and particularly the dumping of sewage sludge into the sea is completely prohibited, techniques for efficiently treating sewage sludge have been developed.

Conventionally, organic materials in sewage, such as organic sludge or microorganisms, were flocculated into a mass with water by using polymer flocculants and precipitated. According to this treatment method, sludge masses having a specific gravity of about 1.2 were separated and collected.

However, the sewage sludge masses formed of flocculated organic materials such as microorganisms and separated as described above were not sufficiently reduced even after being subjected to a mechanical dewatering process using a centrifugal separator, and still had a water content of 80% or more.

The first reason for the insufficient reduction was the binding of organic sludge microflocs having a microfloc size of less than 150 μm to one another due to the capillary action therebetween, which prevented surface water outside the microorganisms from being easily removed.

The second reason for the insufficient reduction was the presence of microorganisms in the sewage, which were not destroyed. The water of crystallization (body water) present inside the microorganisms accounts for about 40% of the total water remaining in the sewage sludge after the flocculation treatment.

Therefore, conventionally, it was required that secondary treatment such as thermal treatment, drying, and incineration be performed in order to meet the water content standards suitable for recycling or landfill treatment even after dewatering the flocculated and separated sewage sludge by a mechanical method.

Accordingly, in Korean Laid-Open Patent Application No. 2015-0056429, Korean Laid-Open Patent Application No. 2015-0056472, and Korean Laid-Open Patent Application No. 2015-0056473, hydrocarbon-based organic solvents were used for extracting and separating organic materials from sewage sludge to further lower the water content.

When a hydrocarbon-based organic solvent is added to sewage sludge, organic sludge and microorganisms move toward the organic solvent and are attached and extracted. Therefore, there is an effect of extracting surface water from among organic sludge and extracting water of crystallization from the inside of the microorganisms by destroying the microorganisms.

However, the conventionally used hydrocarbon-based organic solvents were in a solid state at atmospheric pressure and room temperature and thus did not evenly spread throughout organic sludge upon input, so there was a limit to lowering the total water content.

In addition, the conventionally used hydrocarbon-based organic solvents had relatively long carbon chains which were rheologically disadvantageous, and had a low selective adsorption rate of organic materials present in the sewage sludge.

In addition, the conventionally used hydrocarbon-based organic solvents had a lower specific gravity than water, but the specific gravity was not sufficiently low, so after organic materials are adsorbed, the solvents' ability to separate the organic materials by causing the organic materials to rise above water was low, and residence time (R/T) was long.

In particular, as shown in FIG. 1, in Korean Patent Registration No. 10-1827305, the treatment of sewage sludge was carried out by mixing the sewage sludge with a hydrocarbon-based organic solvent and inputting the mixture into a separation reactor 50 and thus forming a mixed material layer 56 including the organic solvent and the sewage sludge.

In this case, above the mixed material layer 56, the hydrocarbon-based organic solvent having a lower specific gravity than water and organic materials to which the organic solvent is attached rose and formed a collection layer 57, and below the mixed material, water and inorganic material having a higher specific gravity sank and formed a precipitate layer 55.

In this case, ideally, the collection layer 57 including organic materials and the precipitate layer 55 including inorganic materials respectively formed above and below the mixed material layer 56 should be separated while forming a clear boundary.

However, conventionally, due to various reasons including interlayer diffusion, convection, and mixing, the collection layer 57 and the precipitate layer 55 above and below the mixed material layer 56 were not clearly separated, so organic material treatment (separation) efficiency was low.

Accordingly, an entrainment bypass of 20% or more occurred in each of the collection layer 57 and the precipitate layer 55, so a separation efficiency curve in the separation reactor 50 was misplaced by 40% or more as compared to the ideal case.

### DISCLOSURE

### Technical Problem

The present invention is directed to providing a multistage separation reaction tank for treating sewage sludge by forming a collection layer, a diffusion layer, a primary buffer layer, a secondary buffer layer, and an inorganic precipitate layer when treating an organic material by adding a liquid solvent having a lower specific gravity than water to the sewage sludge.

In addition, the present invention is directed to providing a method of treating sewage sludge using an alkane-based solvent, which significantly lowers the water content of the sewage sludge using an alkane-based solvent that is in a liquid state and non-polar at atmospheric pressure and room temperature.

### Technical Solution

One aspect of the present invention provides a multistage separation reaction tank for treating an organic material by adding a liquid solvent having a lower specific gravity than water to sewage sludge including water, the organic material, and an inorganic material, which includes: a reactor body having an accommodation space therein; a first connection pipe connected to an upper portion of the reactor body; a second connection pipe connected to the reactor body and disposed below the first connection pipe; a third connection pipe connected to the reactor body and disposed below the second connection pipe; a mixing device configured to supply a mixture of the liquid solvent and the sewage sludge into the reactor body through the first connection pipe; a solvent spraying device configured to spray droplets of the liquid solvent into the reactor body through the second connection pipe; and an aeration device configured to inject air bubbles into the reactor body through the third connection pipe, so that a diffusion layer in which the liquid solvent and the sewage sludge are diffused is formed by the mixture supplied through the first connection pipe, the liquid solvent and organic material rise from the diffusion layer and form a collection layer above the diffusion layer, a primary buffer layer is formed below the diffusion layer by the liquid solvent droplets sprayed through the second connection pipe, the air bubbles injected through the third connection pipe are supplied to the water and inorganic material that have sunk at the bottom of the primary buffer layer, whereby a secondary buffer layer is formed, and an inorganic precipitate layer which is deposited separately from the secondary buffer layer including the air bubbles and in which water and an inorganic material are deposited is formed below the secondary buffer layer.

Another aspect of the present invention provides a method of treating sewage sludge using an alkane-based solvent, in which an organic material is extracted from sewage sludge and treated using the above-described multistage separation reaction tank and which includes: an organic material separation step of introducing an alkane-based solvent and the sewage sludge to the multistage separation reaction tank and thus separating microorganisms and organic sludge attached to the solvent from surface water present outside the microorganisms; and an organic material concentration step of diffusing the non-polar solvent into the inside of the microorganisms and thus inducing the cell membrane destruction of the microorganisms by turgor pressure, wherein, since the cell membrane is destroyed, the water of crystallization remaining inside the microorganisms is discharged to the outside and separated. Here, the solvent introduced in the organic material separation step is the above-described alkane-based solvent that is in a liquid state at atmospheric pressure and room temperature, and the microorganisms and organic sludge attached to the solvent rise above water due to the solvent having a specific gravity of less than 1 and thus are separated from the water.

In this case, the method additionally includes a pretreatment step for inputting the solvent, and the pretreatment step preferably includes: a concentration measurement step of measuring mixed liquor suspended solid (MLSS) which is a mixture-averaged concentration of suspended materials of the sewage sludge; and an input amount determining step of determining an input amount of solvent based on the measured MLSS.

The pretreatment step additionally includes a concentration adjusting step of lowering the MLSS of the sewage sludge to less than 5,000 [ppm] through dilution, and one or more among the surface water separated in the organic material separation step or the water of crystallization separated in the organic material concentration step are preferably reintroduced into the sewage sludge so that the MLSS of the sewage sludge can be maintained at a system-appropriate level.

In addition, the sewage sludge added in the organic material separation step is preferably sewage sludge that has been treated in an aerobic tank, a sedimentation tank, or a concentration tank of a sewage treatment plant sequentially equipped with a chemical treatment tank, the aerobic tank, the sedimentation tank, the concentration tank, and a dewatering device.

### Advantageous Effects

As described above, according to the present invention, a collection layer, a diffusion layer, a primary buffer layer, a secondary buffer layer, and an inorganic precipitate layer are formed when treating an organic material by adding a liquid solvent having a lower specific gravity than water to sewage sludge. Accordingly, the primary buffer layer and the secondary buffer layer make the separation of the layers possible.

In addition, according to the present invention, it is possible to significantly lower the water content of sewage sludge using an alkane-based solvent that is in a liquid state and non-polar at atmospheric pressure and room temperature. Therefore, despite the capillary action between the small-sized organic materials, the organic materials are adsorbed to the solvent and thus separated from water, and extraction occurs among sewage sludge by the liquid solvent.

In addition, the non-polar solvent permeates the phospholipid bilayer forming the cell membrane of microorganisms by simple diffusion, and as the cell membranes of the microorganisms are destroyed by the turgor pressure caused by the solvent diffused into the microorganisms, even water inside the microorganisms can be separated and removed.

### DESCRIPTION OF DRAWINGS

FIG. 1 is a diagram illustrating a layer structure of a related-art separation reactor.

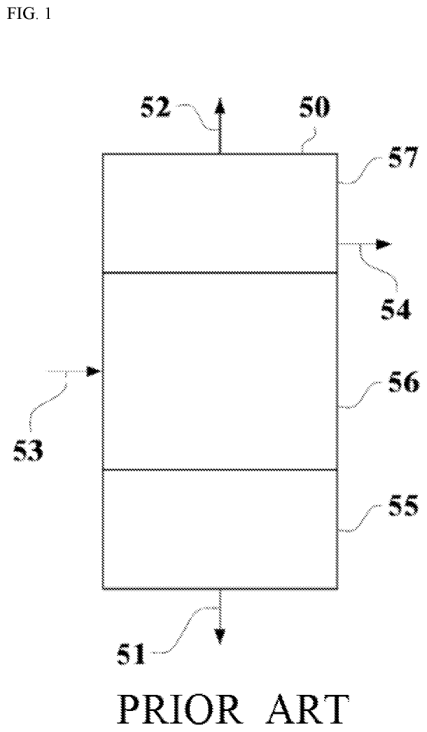

FIG. 2 is a flowchart illustrating a method of treating sewage sludge using an alkane-based solvent according to the present invention.

FIG. 3 is a diagram illustrating a sewage sludge treatment system to which the present invention is applicable.

FIG. 4 is a diagram illustrating a state in which an organic material is selectively adsorbed to a solvent of the present invention.

FIG. 5 is a diagram illustrating a multistage separation reaction tank of the present invention.

FIG. 6 is a table of characteristics of treated water and sludge particles following the treatment of the present invention.

### MODES OF THE INVENTION

Hereinafter, a multistage separation reaction tank according to one embodiment of the present invention and a method of treating sewage sludge using an alkane-based solvent by using the same will be described in detail with reference to the accompanying drawings.

However, in the following, the method of treating sewage sludge using an alkane-based solvent according to the present invention will be first described, and then the multistage separation reaction tank of the present invention will be described as one specific example that is applicable to the method.

Therefore, it will be understood that although a separation reactor of the present invention is illustrated as being optimized for the method of treating sewage sludge using an alkane-based solvent according to the present invention, the separation reactor can also be used with the other types of liquid solvents.

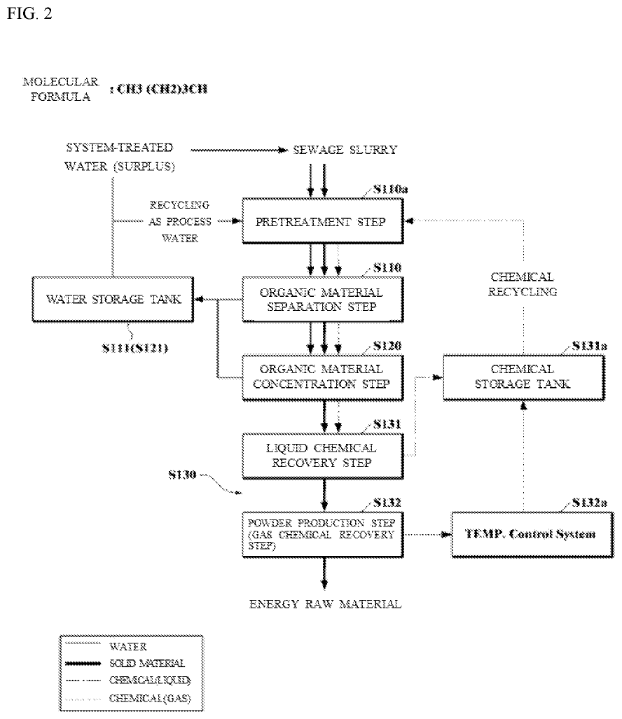

First, as described in FIG. 2, a method of treating sewage sludge using an alkane-based solvent according to one exemplary embodiment of the present invention includes an organic material separation step S110 and an organic material concentration step S120.

In addition, in one exemplary embodiment, the method may additionally include a solvent recovery step S130 after the organic material concentration step S120, and a pretreatment step S110a before the organic material separation step S110.

In the present invention as described above, an alkane-based solvent is added to sewage sludge (or slurry) which includes water, microorganisms, organic sludge, some inorganic materials, heavy metals, and the like in order to extract and treat organic materials such as the microorganisms and the organic sludge.

In this case, in the organic material separation step S110, since the organic materials are attached to the alkane-based solvent and rise, the organic materials contained in the sewage sludge are separated from surface water. The surface water refers to water in sewage sludge that is present between organic materials.

In the organic material concentration step S120, the non-polar alkane-based solvent diffuses into the microorganisms by simple diffusion, and as cell membranes of the microorganisms are destroyed by turgor pressure, the water of crystallization (body water) remaining inside the microorganisms is discharged to the outside, and as a result, the water of crystallization is separated from the organic material.

In the solvent recovery step S130, the solvent attached to the organic material separated from water (surface water and water of crystallization) is recovered so that the solvent can be reused. As will be described below, the recovered solvent may be a liquid phase or a gas phase formed by vaporizing the liquid phase.

Hereinafter, the present invention as described above will be described in greater detail, beginning with the pretreatment step.

First, in the pretreatment step S110a, an alkane-based solvent (hereinafter referred to as “‘solvent”) and sewage sludge are maintained at system-appropriate levels optimized for treatment. To this end, the pretreatment step includes a concentration measurement step, an input amount determining step, a concentration adjusting step, and a stirring step.

In the concentration measurement step, MLSS, which is a mixture-averaged suspended material concentration, of the sewage sludge is measured, and in the input amount determining step, the input amount of solvent is determined based on the MLSS determined in the above.

It is very important that the MLSS of sewage sludge to be treated is maintained at a system-appropriate level, and it is necessary to optimize the MLSS, as with the case of incinerating solid fuels in an incinerator, where complete combustion occurs only on the exterior and incomplete combustion occurs inside.

For example, it is preferable that the MLSS of sewage sludge is less than 5,000 [ppm], and when the MLSS of the sewage sludge exceeds 5,000 [ppm], it is difficult to achieve selective adsorption between the organic material of the sewage sludge and the alkane-based solvent, which are the input raw materials.

Next, in the concentration adjusting step, when the MLSS of the sewage sludge does not satisfy a system-appropriate level, the ratio of water to organic material is adjusted so that the MLSS of the sewage sludge is again maintained at a system-appropriate level.

That is, when the MLSS of the sewage sludge exceeds 5,000 [ppm], water is added for dilution so that the MLSS becomes less than 5,000 [ppm]. Preferably, as the water added for maintaining a system-appropriate level, the surface water separated in the organic material separation step S110 and/or the water of crystallization separated in the organic material concentration step S120 are reused.

Next, in the stirring step, contaminants contained in sewage sludge are removed, and the sewage sludge is uniformly stirred in a stirrer equipped with various sensors. Here, the contaminants refer to solid materials and the like which cannot be solvent-extracted.

As described above, the sewage sludge introduced in the pretreatment step S110a is preferably supplied from an existing sewage treatment plant. To this end, the system to which the present invention is applicable may be linked (or connected in parallel) with the equipment of a conventional sewage treatment plant.

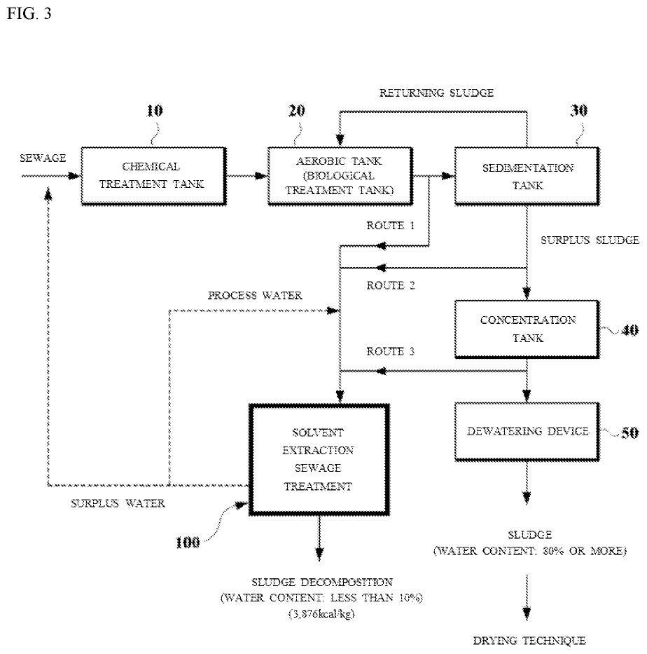

As shown in FIG. 3, a conventional sewage treatment plant includes a chemical treatment tank 10, an aerobic tank 20, a sedimentation tank 30, a concentration tank 40, and a dewatering device 50 as basic equipment.

In the present invention, sewage sludge that has been treated in the aerobic tank 20 or the sedimentation tank 30 among the above-described equipment may be pre-treated and introduced to the organic material separation step S110 to be described below. Of course, in some cases, sewage sludge treated in the concentration tank 40 may be introduced.

In the aerobic tank 20, sewage sludge that has been chemically treated in the chemical treatment tank 10 is biologically treated. The aerobic tank 20 is also referred to as an aeration tank and supplies air (aerates) during activated sewage treatment so that organic materials can be treated using microorganisms.

In addition, the aerobic tank 20 receives sludge returning from the subsequent sedimentation tank 30 and supplies surplus sludge to the concentration tank 40. The surplus sludge is sewage sludge excluding the returning sludge used as a nutrient (carbon component) necessary for maintaining the microorganism ecosystem in the aerobic tank 20.

When supplying sewage sludge from the aerobic tank 20, since sewage sludge in the aerobic tank 20 usually has an MLSS of less than 5,000 [ppm], the sewage sludge does not go through concentration control but only contaminant removal and stirring and then is introduced. Of course, when the MLSS exceeds 5,000 [ppm], process water may be added to lower the MLSS.

In the aerobic tank 20, the MLSS may be monitored using an MLSS measuring instrument installed in the sewage treatment plant. In one example, the MLSS measuring instrument may use an average energy value determined using an ultrasonic attenuation method and an envelope signal and may also monitor the individual equipment of the sewage treatment plant.

Sewage sludge in the sedimentation tank 30 usually has an MLSS of 20,000 [ppm] or more, so the sewage sludge is used after being diluted by adding process water (i.e., surface water and/or water of crystallization) as described above, in which case, the MLSS is adjusted to be less than 5,000 [ppm].

Alternatively, sewage sludge that has been treated in the concentration tank 40 can also be used after adjusting MLSS to be less than 5,000 [ppm] in the same manner.

When the above-described system to which the present invention is applicable is installed to be linked or connected in parallel with equipment of an existing sewage treatment plant, the operation of the concentration tank 40 or dewatering device 50 installed subsequently to the aerobic tank 20 and the sedimentation tank 30 may be stopped or omitted.

However, when using sewage sludge treated in the concentration tank 40 despite its relatively high MLSS and somewhat low efficiency, only the subsequent operation of the dewatering device 50 may be stopped or omitted.

Meanwhile, going back to FIG. 2, in the organic material separation step S110, an alkane-based solvent is added to the sewage sludge to separate the microorganisms and organic sludge attached to the solvent from surface water present outside the microorganisms.

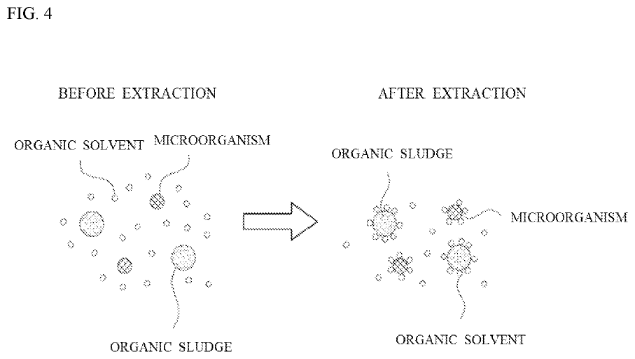

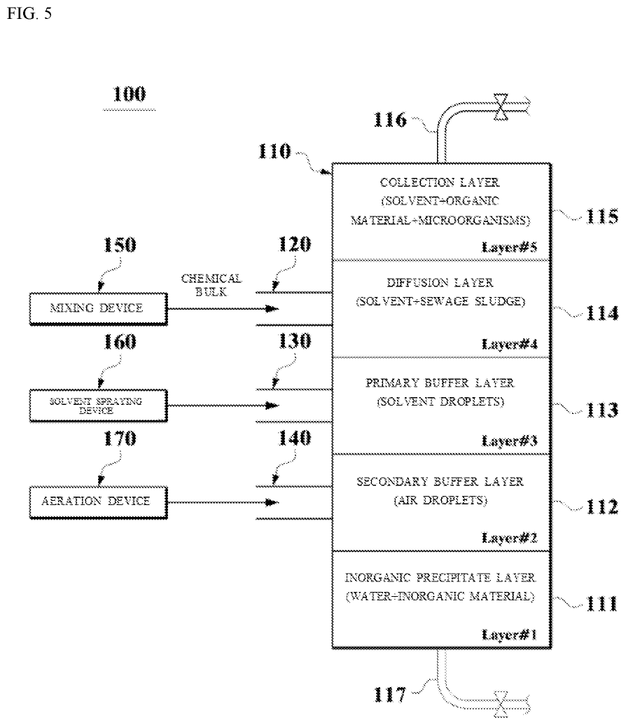

For example, when sewage sludge and a solvent maintained at system-appropriate levels through the pretreatment step S110a are mixed using various mixing devices such as an inline mixer and then introduced into a separation tank (100 of FIG. 5), in the separation tank 100, an organic material is selectively adsorbed to the solvent as shown in FIG. 4. The organic material includes organic sludge and microorganisms.

As will be described below, the solvent, which has a specific gravity of less than 1, and the organic material are separated from water as they rise above the water in the separation tank 100. That is, the solvent to which the organic sludge and the microorganisms are adsorbed are suspended in an upper part of the separation tank 100, and water is separated in a lower part.

The water separated in a lower part of the separation tank 100 is the above-described surface water and is distinguished from the water of crystallization (body water) inside the microorganisms, and in the present invention, water remaining between organic sludge microflocs with a microfloc size of less than 150 μm is separated.

In addition, the separation of the surface water, which was difficult to achieve by conventional mechanical dewatering methods because the surface water is a polar material capable of acid-base interaction and thus has strong attraction among water particles, becomes possible.

In one example, the surface water separated in the organic material separation step S110 is stored in a water storage tank in S111 and then either supplied as process water in the pretreatment step S110a or discharged as treated water from which organic materials have been separated, to a sewage treatment plant.

In this case, since the pH or other properties of the surface water have not changed as compared to when the surface water was initially contained in the sewage sludge, the surface water does not cause a change in water balance in the sewage treatment plant, and the surface water can be reused as process water in the pretreatment step S110a or the like.

As described above, the alkane-based solvent introduced together with sewage sludge in the organic material separation step S110 is preferably an alkane-based solvent that is in a liquid state at atmospheric pressure and room temperature.

When the solvent is liquid at atmospheric pressure and room temperature, since the liquid solvent has excellent rheological properties and is uniformly dispersed and diffused in the sewage sludge medium, the solvent extraction effect is significantly improved compared to the case where the solvent is a solid.

In particular, the solvent is preferably n-pentane which is an alkane (CₙH₂ₙ₊₂) with n=5 and a specific gravity of less than 1 or an isomer of the n-pentane such as isopentane or neopentane. Specifically, the n-pentane has a specific gravity of 0.6 to 0.7.

In the present invention, all alkane-based solvents and their isomers can be used. However, it has been found that when n exceeds 16, process efficiency significantly decreases. This is understood to be due to the carbon chains being excessively long.

In addition, in the case of an alkane-based solvent with n=1 to 4, since the solvent is in a gaseous state at atmospheric pressure and room temperature, it is difficult to inject the solvent into the sewage sludge or solvent extraction is not achieved, and the solvent diffuses into the atmosphere, and thus, process complexity increases.

In consideration of the above points, in the present invention, n-pentane, which has the shortest and simplest carbon ring among alkane-based solvents that are in a liquid state at atmospheric pressure and room temperature and thus has the best ability to selectively adsorb an organic material in sewage sludge, or an isomer thereof is selected.

Furthermore, since n-pentane and isomers thereof have the lowest molecular weight among the liquid alkanes and a small specific gravity of 0.6 to 0.7, they have the best ability to selectively adsorb an organic material and rise and have the ability to cause the organic material to rise and be separated within a short R/T.

Meanwhile, FIG. 5 illustrates a multistage separation reaction tank of the present invention. In the multistage separation reaction tank 100, a liquid solvent which can easily diffuse in sewage sludge mixed with water is used, and there is no particular limitation on the applicable solvent as long as it can be attached to an organic material and rise.

However, the solvent applied to the multistage separation reaction tank 100 of the present invention is preferably an alkane-based solvent that is non-polar and has a specific gravity of less than 1. As described above, the solvent is n-pentane, which is an alkane with n=5 and a specific gravity of less than 1, or an isomer of the n-pentane such as isopentane or neopentane.

As illustrated, the present invention for treating an organic material in sewage sludge including water, the organic material, and an inorganic material by adding a liquid solvent having a lower specific gravity than water includes a reactor body 110, a first connection pipe 120, a second connection pipe 130, a third connection pipe 140, a mixing device 150, a solvent spraying device 160, and an aeration device 170.

Here, the reactor body 110 is a single reactor having an accommodation space therein, and as will be described below, five layers 111 to 115 (from bottom to top) are formed on top of one another. The five layers are Layers #1 to #5, and are separated according to specific gravity.

The first connection pipe 120 to the third connection pipe 140, which are connected to one side of the reactor body 110, inject water, sewage sludge, the solvent, air, and the like so that the above-described plurality of separated layers 111 to 115 are formed, and therefore, inorganic materials and organic materials are separated, as the lowermost layer and the uppermost layer, respectively.

The mixing device 150, the solvent spraying device 160, and the aeration device 170 are for processing the above-described injected water, sewage sludge, solvent, air, and the like, wherein the solvent (e.g., alkane solvent) is mixed with the sewage sludge, and the solvent or the air is formed into droplets or bubbles.

More specifically, the first connection pipe 120 is connected to an upper part of the reactor body 110 having an accommodation space therein, and the second connection pipe 130 is disposed below the first connection pipe 120. The third connection pipe 140 is disposed below the second connection pipe.

Since the first connection pipe 120, the second connection pipe 130, and the third connection pipe 140 (from top to bottom of the reactor body 110) are installed as described above, the first connection pipe 120 is located in a diffusion layer 114, which is Layer #4. The second connection pipe 130 is located in a primary buffer layer 113, which is Layer #3, and the third connection pipe 140 is located in a secondary buffer layer 112, which is Layer #2.

Next, the mixing device 150 supplies a mixture of the liquid solvent and the sewage sludge into the reactor body 110 through the first connection pipe 120. As described above, an inline mixer may be used as the mixing device 150.

The inline mixer includes a circulation mixer and a solvent injection mixer. Among these, the circulation mixer facilitates the uniform dispersion and separation of organic materials in the sewage sludge. The solvent injection mixer is used for the solvent adsorption and uniform dispersion of the organic materials.

The solvent spraying device 160 sprays droplets of the liquid solvent into the reactor body 110 through the second connection pipe 130. To this end, in one example, the solvent spraying device 160 receives the solvent from a storage tank configured to supply an alkane-based solvent and sprays the solvent.

The solvent sprayed through a bubbling device to form solvent droplets forms submicron- or nano-sized chemical droplets. Preferably, the solvent is uniformly sprayed throughout the primary buffer layer 113, and at the same time, stably sprayed to minimize sloshing.

The aeration device 170 injects air bubbles into the reactor body 110 through the third connection pipe 140. To this end, the aeration device 170 includes an outdoor-air intake fan, an air bubble generator, and the like, and forms submicron- or nano-sized air bubbles.

Therefore, in the present invention, the diffusion layer 114 in which the liquid solvent and the sewage sludge are diffused is formed by the mixture supplied through the first connection pipe 120, and the liquid solvent and the organic material rise from the diffusion layer 114 and form the collection layer 115 above the diffusion layer 114.

In addition, the primary buffer layer 113 is formed below the diffusion layer 114 by the liquid solvent droplets sprayed through the second connection pipe 130, and the air bubbles injected through the third connection pipe 140 are supplied to the water and inorganic material that have sunk at the bottom of the primary buffer layer 113, whereby the secondary buffer layer 112 is formed.

Below the above-described secondary buffer layer 112, the inorganic precipitate layer 111 is formed. The inorganic precipitate layer 111 is deposited separately from the secondary buffer layer 112 including air bubbles injected by the aeration device 170, and includes water and an inorganic material deposited therein.

As described above, in the inorganic precipitate layer 111 which is the lowermost layer, water and inorganic materials having a large specific gravity precipitate, and in the collection layer 115 which is the uppermost layer, organic materials are attached to the solvent having a low specific gravity and rise with the solvent, and the water and inorganic materials and the solvent and organic materials are clearly separated from each other by the plurality of layers therebetween.

In addition, since the primary buffer layer 113 is formed below the diffusion layer 114 in which the solvent and the sewage sludge are mixed, the organic materials and the solvent are attached to and/or entrapped by the solvent droplets uniformly distributed in the primary buffer layer 113 and rise and cannot descend any further.

In addition, above and below the secondary buffer layer 112, there are the primary buffer layer 113 and the inorganic precipitate layer 111, respectively, so some of the organic materials and solvent diffusing downward from the primary buffer layer 113 are attached and/or entrapped and rise and cannot descent any further.

Therefore, in the present invention, since interlayer diffusion, convection, mixing, and the like can be prevented, the collection layer 115 and the inorganic precipitate layer 111 are clearly separated, and organic material treatment (separation) efficiency is greatly improved.

That is, entrainment bypass in each of the collection layer 115 and the inorganic precipitate layer 111 becomes less than 5%, so that a separation efficiency curve in the multistage separation reaction tank 100 is misplaced by less than 10% as compared to an ideal case.

Although not described above, a first discharge pipe 116 and a second discharge pipe 117 are connected to the uppermost collection layer 115 and the lowermost inorganic precipitate layer 111, respectively. Therefore, the solvent and organic material, and the water and inorganic material are separately discharged through the first discharge pipe 116 and the second discharge pipe 117, respectively.

Next, the organic material concentration step S120 will be described. In the organic material concentration step S120, the non-polar solvent diffuses into the inside of the microorganisms and induces the cell membrane destruction of the microorganisms by turgor pressure, and since the cell membrane is destroyed, the water of crystallization remaining inside the microorganisms is discharged to the outside and separated.

For example, the sludge consisting of microorganisms, organic sludge, and solvent, from which surface water has been separated while being treated in the organic material separation step S110 in the separation tank 100, is sent to the concentration tank 40, and in the concentration tank 40, a step for separating water of crystallization is performed.

According to mechanical dewatering techniques developed in the past (e.g., centrifugal dewatering or various filtering techniques), the water content of sewage sludge exceeded 80%, 40% of which was water of crystallization inside microorganisms.

However, only with the driving force of the mechanical dewatering techniques, it was difficult to remove the water of crystallization remaining inside microorganisms, and since the water of crystallization is distributed in small amounts among the microorganisms, it was practically impossible to separate the water by mechanical means.

Therefore, in the present invention, a non-polar alkane-based solvent that easily diffuses into the cell membrane is used. In particular, n-pentane, which has the shortest carbon ring (n=5) among the alkanes that are in a liquid state at room temperature, and isomers thereof are used.

Therefore, in the present invention, a solvent which is non-polar, liquid at room temperature, and has a short carbon ring is used, so the solvent passes through microorganism cell membranes formed of phospholipid bilayers and diffuses by simple diffusion, and a turgor pressure resulting thereby destroys the cell membranes of the microorganisms.

As cell membranes are destroyed, the water of crystallization (body water) that was once present inside the microorganisms is separated from the solvent. The water of crystallization has a larger specific gravity than the solvent and thus descends, and the organic material adsorbed to the remaining solvent rises and thus is separated from the water of crystallization.

In one example, the water of crystallization separated in the organic material concentration step S120 is stored in a water storage tank in S121 and then either supplied as process water in the pretreatment step S110a or discharged as treated water from which organic materials have been separated, to a sewage treatment plant. The sludge from which the water of crystallization has been removed is in a concentrated state.

As described above, since the pH or other properties of the water of crystallization also have not changed as compared to when the water of crystallization was initially contained in the sewage sludge, the water of crystallization does not cause a change in water balance in the sewage treatment plant, and the water of crystallization can be reused as process water in the pretreatment step S110a or the like.

Next, in the solvent recovery step S130, the solvent which was introduced together with sewage sludge in the above-described pretreatment step S110a and then subjected to the organic material separation step S110 and the organic material concentration step S120 is separated and recovered.

The solvent recovery step S130 includes a liquid solvent recovery step S131 for recovering a liquid solvent. In addition, in one exemplary embodiment, the solvent recovery step S130 includes a gas solvent recovery step S132 in order to recover a gas solvent in addition to recovering a liquid solvent.

In this case, in the liquid solvent recovery step S131, the liquid solvent attached to microorganisms and organic sludge is separated using a dehydrator and recovered. As the dehydrator, various types such as a vacuum dehydrator, a high-pressure dehydrator, a centrifugal dehydrator, and the like can be used.

The liquid solvent recovered in the liquid solvent recovery step S131 is stored in a solvent storage tank S131a, and the stored solvent is supplied for the above-described pretreatment step S110a. Of course, in some cases, the solvent may be directly supplied for the organic material separation step S110.

Next, in the gas solvent recovery step S132, during the treatment of sewage sludge by a solvent extraction method using the liquid solvent, a gas solvent present in a vaporized state in the air or on the surface of the liquid solvent is recovered.

In order to recover the gas solvent, the entropy of the gas solvent is increased using compressed air in a vaporization activation tank, and the captured gas solvent is transferred to a condenser and liquefied (condensed) in S132a. The compressed air is supplied by an air cyclone device or the like installed in the vaporization activation tank.

The liquid solvent recovered and condensed in the gas solvent recovery step S132 is also stored in the solvent storage tank, and the stored solvent is supplied for the above-described pretreatment step S110a. Of course, in some cases, the solvent may be directly supplied for the organic material separation step S110.

In particular, in order to maximize gas solvent capture efficiency, the vaporization activation tank and peripheral devices may form a closed circuit isolated from the external environment, and preferably, all of the previous processes form closed circuits.

As described above, when sewage sludge generated in the conventional sewage treatment plants is applied to the present invention, there is an advantage in that reduction techniques (e.g., mechanical dewatering techniques, thermal drying techniques, etc.), recycling techniques, landfill techniques, and the like are integrated into one.

Conventionally, sewage sludge discharged after being subjected to mechanical dewatering in sewage treatment plants had a water content of about 80%. On the other hand, the present invention enables an additional reduction of 78%, so that the sewage sludge can be used as an alternative energy source having a high calorific value.

In addition, conventionally, sewage sludge generated in sewage treatment plants contained a lot of water even after being subjected to mechanical reduction, and therefore, additional thermal treatment and dry incineration processes were required. However, according to the present invention, these additional processes can be omitted.

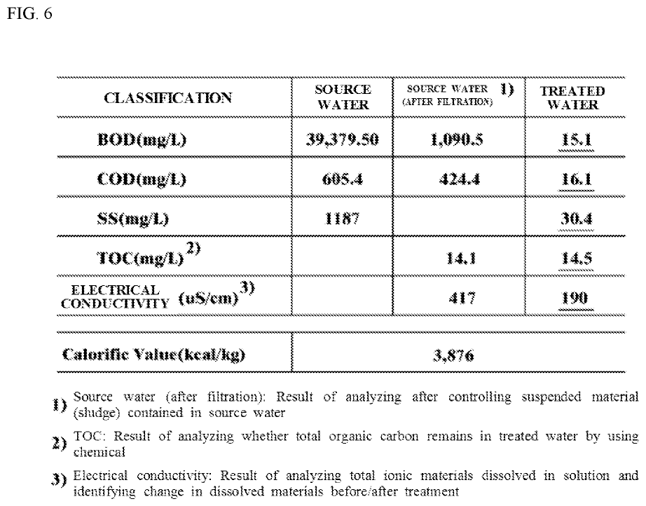

Furthermore, as shown in FIG. 6, according to the present invention, treated water with improved biochemical oxygen demand (BOD), chemical oxygen demand (COD), suspended solids (SS), total organic carbon (TOC), and electrical conductivity is discharged. In particular, sludge particles from which surface water and water of crystallization have been removed and which have a water content of less than 10% are generated.

Since sludge particles having a water content of only less than 10% have a calorific value of about 3,876 [kcal/kg], it is no longer necessary to landfill the sludge particles after the sewage sludge treatment, and the sludge particles can be used as a renewable energy source.

### INDUSTRIAL APPLICABILITY

In the above, specific exemplary embodiments of the present invention have been described. However, it will be understood by those of ordinary skill in the art to which the present invention pertains that the spirit and scope of the present invention are not limited to these specific embodiments, and that various modifications and changes can be made without changing the gist of the present invention.

Since the above-described exemplary embodiments are provided to fully describe the scope of the invention to those of ordinary skill in the art to which the present invention pertains, it should be understood that the embodiments are illustrative in all respects and not restrictive, and that the present invention is defined only by the scope of the appended claims.

1. A method of treating sewage sludge using an alkane-based solvent, in which an organic material is extracted from the sewage sludge and treated using a multistage separation reaction tank, the method comprising:
an organic material separation step (S110) of introducing the alkane-based solvent and the sewage sludge into the multistage separation reaction tank and thus separating microorganisms and organic sludge attached to the solvent from surface water present outside the microorganisms; and
an organic material concentration step (S120) of diffusing the solvent, which is non-polar, into the inside of the microorganisms and thus inducing the cell membrane destruction of the microorganisms by turgor pressure, wherein, since the cell membrane is destroyed, the water of crystallization remaining inside the microorganisms is discharged to the outside and separated,
wherein:
the solvent introduced in the organic material separation step (S110) is the alkane-based solvent which is in a liquid state at atmospheric pressure and room temperature, and the microorganisms and organic sludge attached to the solvent rise above water due to the solvent having a specific gravity of less than 1 and thus are separated from the water;
the sewage sludge introduced in the organic material separation step (S110) is sewage sludge which has been treated in an aerobic tank (20), a sedimentation tank (30), or a concentration tank (40) of a sewage treatment plant sequentially equipped with a chemical treatment tank (10), the aerobic tank (20), the sedimentation tank (30), the concentration tank (40), and a dewatering device (50);
the method further includes a pretreatment step (S110a) for inputting the solvent, wherein the pretreatment step (S110a) includes: a concentration measurement step of measuring mixed liquor suspended solid (MLSS) which is a mixture-averaged concentration of suspended materials of the sewage sludge; and an input amount determining step of determining an addition amount of solvent based on the measured MLSS, and further includes a concentration adjusting step of lowering the MLSS of the sewage sludge to less than 5,000 [ppm] through dilution; and
one or more among the surface water separated in the organic material separation step (S110) or the water of crystallization separated in the organic material concentration step (S120) are reintroduced into the sewage sludge so that the MLSS of the sewage sludge is maintained at a system-appropriate level.
